(19) United States
(12) Patent Application Publication
(10) Pub. No.: US 2022/0138872 A1
(43) Pub. Date: May 5, 2022

(54) COMPUTER-AIDED TECHNIQUE FOR ASSESSING INFRASTRUCTURE RELIABILITY AND RESILIENCE AND RELATED SYSTEMS, METHODS, AND DEVICES

(71) Applicant: Battelle Energy Alliance, LLC, Idaho Falls, ID (US)

(72) Inventors: Bjorn C. Vaagensmith, Idaho Falls, ID (US); Jesse L. Reeves, Ammon, ID (US); James R. Case, Ammon, ID (US); Timothy R. McJunkin, Idaho Falls, ID (US); Kurt G. Vedros, Ammon, ID (US); Liam D. Boire, Idaho Falls, ID (US); Jason A. Wayment, Idaho Falls, ID (US); Craig G. Rieger, Pocatello, ID (US)

(21) Appl. No.: 17/269,448

(22) PCT Filed: Aug. 20, 2019
(86) PCT No.: PCT/US2019/047253

§ 371 Date: Feb. 18, 2021

Related U.S. Application Data
(60) Provisional application No. 62/720,618, filed on Aug. 21, 2018.

(51) Int. Cl. G06Q 50/06; G06Q 10/06

(52) U.S. Cl. CPC G06Q 50/06; H02J 3/00; H02J 2203/20; G06Q 10/0635

(57) ABSTRACT

Described are systems, methods and devices for computer-aided infrastructure assessment. Some embodiments relate to computer-aided assessment of infrastructure using combinations of probabilistic risk assessment, resource delivery simulation, and physics-based resilience analysis.

### CROSS-REFERENCE TO RELATED APPLICATIONS

This application is a national phase entry under 35 U.S.C. § 371 of International Patent Application PCT/US2019/047253, filed Aug. 20, 2019, designating the United States of America and published as International Patent Publication WO 2020/041302 A1 on Feb. 27, 2020, which claims the benefit under Article 8 of the Patent Cooperation Treaty to U.S. Patent Application Ser. No. 62/720,618, filed Aug. 21, 2018.

### SPONSORED RESEARCH OR DEVELOPMENT

The invention was made with government support under Contract No. DE-AC07-05-ID14517, awarded by the United States Department of Energy. The government has certain rights in this invention.

### TECHNICAL FIELD

Embodiments of this disclosure relate, generally, to computer-aided assessment of infrastructure, and more specifically, some embodiments relate to computer-aided assessment of infrastructure using a combination of probabilistic risk assessment, resource delivery simulation, and physics-based resilience analysis.

### BACKGROUND

Infrastructure reliability is an infrastructure's ability to perform core functions and deliver core services at accepted quality and quantity. Infrastructure simulation and risk assessment techniques are used to assess an infrastructure's reliability. For example, in the case of the power systems, reliability is the study of the ability of power systems to deliver electricity in the quantity and with the quality demanded by users. Power system simulations and probabilistic risk assessments are used for power system reliability analysis. Application of a system-of-systems approach to power system simulations can agnostically identify super components and combinations of super components of a power system that, if they failed, would result in failure of the power system as a whole. Super components in a power system may include, by way of non-limiting example, transformers, power lines, power supply, capacitors, and breakers. Probability risk assessment may be used to analyze the effect of specific disturbances on the power system (called herein “scenarios”), and the most likely components to experience failures under a specific scenario.

Resiliency of an infrastructure is defined as a measure of an infrastructure's ability to absorb, adapt, and/or respond to disturbances. Resiliency assessment of a power system involves understanding how the power system responds to a disturbance, and often involves creating a behavioral model of a power system that seeks to characterize the system's response to disturbances. Resiliency assessment is beginning to gain acceptance as a complement to reliability assessment.

Presently, infrastructure simulation and probabilistic risk assessment are used independently. Further, neither infrastructure simulation nor probability risk assessment is used collaboratively with resiliency assessment.

As the complexity of infrastructures—such as power systems, information delivery systems, security system, water distribution systems, oil and gas pipelines—increase, the frequency of service outages increase, and costs and delivery times increase for critical components on repairs and modernization, the inventors of this disclosure foresee a need for collaborative tools and new methodologies to identify critical weak points of an infrastructure, and to assess and prioritize investments and improvements based on the need for developing greater reliance on infrastructures.

### BRIEF DESCRIPTION OF THE DRAWINGS

To easily identify the discussion of any particular element or act, the most significant digit or digits in a reference number refer to the figure number in which that element is first introduced.

FIG. 1 illustrates a block diagram of computing platform in accordance with one or more embodiments.

FIG. 2 illustrates a flowchart of a process for a power flow simulation process in accordance with one or more embodiments.

FIG. 3 illustrates a flowchart of a process for a probability risk assessment in accordance with one or more embodiments.

FIG. 4 illustrates a flowchart of a process in accordance with one or more embodiments.

FIG. 5 illustrates a flowchart of a process in accordance with one or more embodiments.

FIG. 6 illustrates a diagram of transmission system in accordance with one or more embodiments.

FIG. 7 illustrates a graph in accordance with one or more embodiments.

### DETAILED DESCRIPTION

In the following detailed description, reference is made to the accompanying drawings, which form a part hereof, and in which are shown, by way of illustration, specific example embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

It will be readily understood that the components of the embodiments as generally described herein and illustrated in the drawings may be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

Thus, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the disclosure may be implemented on any number of data signals including a single data signal.

It should be understood that any reference to an element herein using a designation such as “first,” “second,” and so forth does not limit the quantity or order of those elements, unless such limitation is explicitly stated. Rather, these designations are used herein as a convenient method of distinguishing between two or more elements or instances of an element. Thus, a reference to first and second elements does not mean that only two elements can be employed or that the first element must precede the second element in some manner. Also, unless stated otherwise a set of elements may comprise one or more elements. Likewise, sometimes elements referred to in the singular form may also include one or more instances of the element.

The various illustrative logical blocks, modules, and circuits described in connection with the embodiments disclosed herein may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Also, it is noted that the embodiments may be described in terms of a process that is depicted as a flowchart, a flow diagram, a structure diagram, or a block diagram. Although a flowchart may describe operational acts as a sequential process, many of these acts may be performed in another sequence, in parallel, or substantially concurrently. In addition, the order of the acts may be re-arranged. A process may correspond to a method, a thread, a function, a procedure, a subroutine, a subprogram, etc. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

One or more embodiments of the disclosure relate, generally, to an infrastructure assessment method that combines infrastructure simulations, probabilistic risk assessment, and resiliency assessment.

Any form of infrastructure simulation may be used for modeling, simulating, and analyzing the infrastructure. Types of infrastructure simulation include, for example, fault analysis, contingency analysis, protection analysis, system stability under transient disturbances, quality analysis, and optimization analysis. For resource delivery systems, such as power systems, information delivery systems, security system, water distribution systems, and oil and gas pipelines, flow analysis as part of a contingency analysis (i.e., study of a large “load” on some or all of the system, that is, a large amount of resource, for example, because of large demand or because part of the system is down) may be performed.

In the case of contingency analysis, super component failures and combination of super component failures are identified that would result in an infrastructure failure. Probabilistic risk assessment is performed to determine and rank likely scenarios that may occur under a variety of conditions (e.g., extreme weather, earthquake, explosions, terrorist attacks, vandalism, islanding, generation inadequacy, transmission interruption, system operations, etc.) and the components of a system most likely to fail.

Resiliency assessment is performed based on the results of the power flow simulation and probabilistic risk assessment, to develop a deep understanding of power system sensitivities, including those not inherently obvious from the probabilistic risk assessment and/or power flow contingency analysis. In one embodiment, adaptive capacity resiliency metrics are used for the resiliency assessment. “Adaptive capacity” is the capacity (which also may be characterized as the “ability”) of a system to adapt if the environment where the system exists changes. Examples of characteristics that contribute to a system's adaptive capacity are a system's ability to “absorb” change and a system's ability to “correct” for change. Absorbing change means that the system can continue to operate similar to the manner it did before the change without any significant corrections. Correcting for change means that the system will adjust its behavior (e.g., programming, tolerances, etc.) in order to continue to operate within its tolerances.

In one embodiment, benefits of infrastructure upgrades are quantified in a revised probabilistic risk assessment (e.g., decreasing the likelihood of a component failure probability), increasing a component's resiliency (e.g., adaptive capacity), or by topological changes via power system flow analysis and resiliency metrics.

While one of ordinary skill in the art would understand that there are many benefits and applications for the embodiments described herein, utilities will, in particular, be able to make informed system upgrade decisions by comparing simulated improvements to upgrade costs.

The computing platforms described herein also provide advantages over existing computer aided design and analysis tools known to the inventors of this disclosure. For example, others have used power flow simulation and probability risk assessment packages independently and not in a collaborative manor. Some software packages have tried to combine probabilistic risk assessment with power flow analysis, for example, attempting to develop fault chain theory as a computationally inexpensive replacement for power flow software. Others still have tried to use multiple decision tree probabilistic risk assessment (commonly referred to as “decision forests”) down to a 6^{th} order to account for the dynamic nature of an electric grid in lieu of a power flow simulation. In each case, these software packages sought to provoke a competition between probabilistic risk assessment and infrastructure simulation and therefore did not necessarily realize many benefits of combining techniques. One or more embodiments of this disclosure utilize information, infrastructure simulation/analysis, probability risk assessment, and resiliency assessment in a complementary way, and realize the benefits each technique has to offer.

Accordingly, the techniques and computing platforms that implement them that are described in this disclosure provide a more complete picture of vulnerabilities in infrastructures compared to conventional methods and systems known to inventors of this disclosure. For example, in the case of power systems, power flow simulation provides information about component combinations in a power system that may result in a system failure; probabilistic risk assessment methods are able to translate power flow information into likelihood of occurrence, as well as rank individual components in terms of critically to coherent operations; and resiliency tools may quantify a system margin to maneuver out of a critical state and/or its capacity to endure additional disturbances.

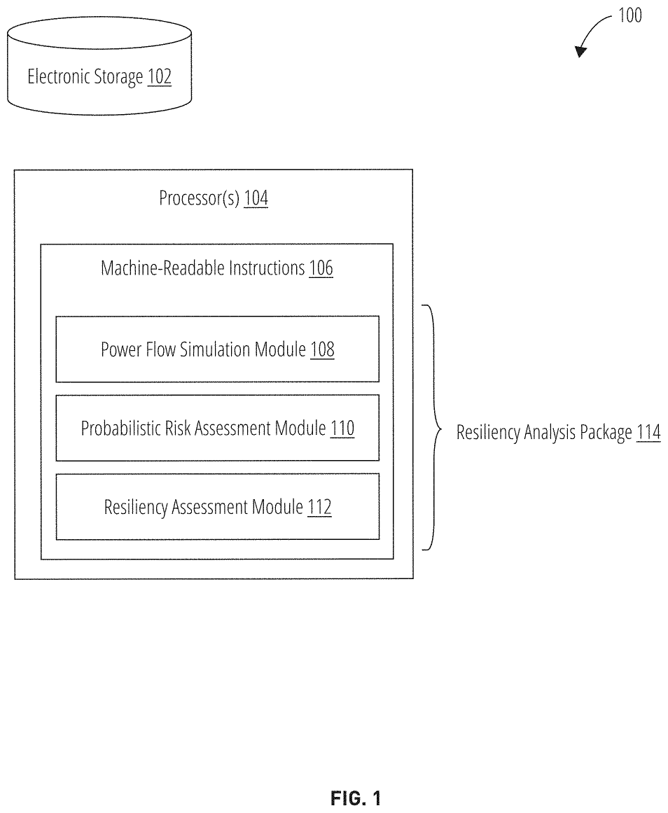

FIG. 1 shows a computing platform 100 for performing power system analysis, in accordance with one or more embodiments. Unless specifically stated, use in this disclosure of the term “power system” in FIGS. 1 to 7 and discussion thereof is intended to apply to infrastructure systems, generally.

Computing platform 100 may include an electronic storage 102 and hardware processor(s) 104. Processor(s) 104 may be configured to perform operations responsive to one or more modules of machine-readable instructions 106 and data stored at electronic storage 102. In one or more embodiments, the modules of machine-readable instructions 106 may include power flow simulation module 108, probabilistic risk assessment module 110, and resiliency assessment module 112.

Power flow simulation module 108 may be configured, generally, to perform a power flow simulation for a power system model (such a model may be based on a power system diagram such as a one line diagram), and other component information (e.g., provided in a file of simulation parameters or entered manually by a user).

Various forms of power flow analysis may be performed for the power system on power flow simulations performed by power flow simulation module 108. For example, power flow analysis may include forms of contingency analysis that test system level outcomes of single and double component failures (higher order component failures may also be included). Combinations of components (i.e., “component combinations”) that cause power system failures are identified from the results of the power flow analysis of the various power flow simulations. The identified combinations of components are summarized in component failure analysis results.

As used herein, “failure” or “failing” used in connection with a power system means that, for a core function or operation of the power system, the power system failed to operate within an acceptable operating range (or at all), and so failed. In one embodiment, the operational range is a power system tolerance, and power system tolerance violations (i.e., over voltages, current ampacity, etc.) are used to define power system failures.

Probabilistic risk assessment module 110 may be configured to receive the component failure analysis results from power flow simulation module 108 and perform a probability risk assessment according to one or more scenarios based, at least in part, on the component failure analysis results.

In one embodiment, a probabilistic risk assessment may be performed using a component model that corresponds to the power system model used by power flow simulation module 108. In one embodiment, the component model may be created automatically (e.g., by probabilistic risk assessment module 110 or another software module included with resiliency analysis package 114), in response to a power system model using, for example, a library of standard configurations for components of power systems. Additional configurations for components may be specified by a user. In cases where multiple possible configurations are possible, a configuration may be determined based on a context and/or a user may provide an indication of the correct configuration. In one embodiment, the component model may include a component diagram comprising fault tree diagrams.

In one embodiment, fault tree models that include fault tree diagrams down to a component level are used to simulate and assess a power system. In some embodiments, probabilistic risk assessment module 110 may be configured, in addition to or as an alternative to using fault tree models, to use statistical techniques such as linear regression models, generalized linear models, and generalized additive models to model and evaluate statistical analysis, and capture (i.e., create predictions of) overall system unavailability per some time range (e.g., per hour, 6 hours, day, week, etc.), assuming various substation configurations within the power system, individual super components' unavailability per time period, and most likely scenarios under specific conditions that would cause a power system failure. A list of components most likely to contribute to failure under each scenario and condition may be validated using real world data.

Resiliency assessment module 112 may be configured to receive results from probabilistic risk assessment module 110. Resiliency assessment module 112 may be configured to simulate the most likely scenarios per information (e.g., including system unavailability predictions, without limitation) provided by probabilistic risk assessment module 110 and examine a power system's responses (e.g., including predicted responses, without limitation) to various disturbances at a system level and component level.

In one embodiment, resiliency assessment module 112 may be configured to consider real and reactive capabilities of controllable assets in a power system divided topologically or geographically into economic units (EcUs). In a case of a power system that includes a power distribution system, EcUs of the power distribution system may be, as a non-limiting example, geographical or topological groupings of feeders, buildings, and microgrids.

The controllable assets may be described by resiliency assessment module 112, for example, in terms of a latency to engage, a time to ramp, real and reactive power limits, and energy limits on real power applications of respective controllable assets. Notably, energy limits may be relevant for controllable assets, such as battery storage, that would otherwise indefinitely deplete real power upon continuous use. Controllable assets that may be described by resiliency assessment module 112 include, for example: flexibility in generators and synchronous condensers, flexible loads (e.g., building management systems, demand response), transmission lines, flexible AC transmission/distribution (FACT/D) devices (e.g., dSTATCOMs), and storage devices.

With the description of controllable assets generated by resiliency assessment module 112, the shape of a maximum extent over time that respective controllable assets can, in theory, react to a disturbance may be calculated as a three-dimensional surface. In one embodiment, a three-dimensional surface is summed to illustrate the capability (including capacity) of a group of controllable assets. Following a given component failure or disturbance, the resilience of a power system may then be expressed in terms of the remaining available adaptive capacity.

The characterization of a power system in terms of resilience enables analyses to be divorced from specific scenarios and explore inherent weaknesses in regards to maintaining a minimum normalcy of operation. For example, probabilistic risk assessment analysis only accounts for what typically may fail during some modeled disturbance or combination of disturbances, however an adaptive capacity analysis may reveal weak points in the system not previously realized from past disturbances, thus improving system resilience by enabling insight into unexpected disturbances never before experienced during a system's history. By way of non-limiting example, adaptive capacity analysis may reveal the mostly tightly constrained components in terms of adaptive capacity (i.e., components that do not have much available capacity to help absorb a disturbance). Tightly constrained components may be candidates for replacement or upgrade.

In an ideal situation, resilient strategies may be applied so that overall system reliability benefits. The relationship between resilience and reliability may depend on how a system's operational normalcy is defined. For example, consider a case where a utility agrees to supply power with 99% reliability per year for a factory. In the event a disturbance takes place and the grid suffers from insufficient power generation capacity, the utility is more likely to shed residential load to maintain an acceptable operational normalcy (i.e., supplying power to the factory in order to fulfill their contract). In this scenario, the power system's resilience resulted in a decrease in reliability to residential loads, but an increase in reliability for the factory. Strategies previously utilized to address resilience issues in the electric grid explored the use of distributed generation units (i.e., renewables and diesel generators) and microgrid control algorithms to quickly restore power. While these system-level approaches are useful, they do not provide any information about the most vulnerable components within a system.

Adaptive capacity methods complemented by probabilistic risk assessment may highlight areas for improvement down to the device level to avoid situations where increased resilience negatively impacts reliability. For example, a particular asset, such as a breaker, is found to be a weak point in the power system's ability to absorb a disturbance, which may result in the need for the system to shed load and negatively impact reliability to maintain operations elsewhere. If the probability of failure for this asset can be reduced to negligible levels through new device design or material selections used in fabrication, improved system resilience can translate to system wide improvements in reliability rather than being limited to the realm of minimal operational normalcy. Previous work demonstrates the use of fault chain theory to predict power line combination failures that would result in a system wide blackout. These previous methods were computationally inexpensive; however, do not necessarily rely on physics-based methods for calculating which powerlines fail or favoring some types of failure scenarios over others.

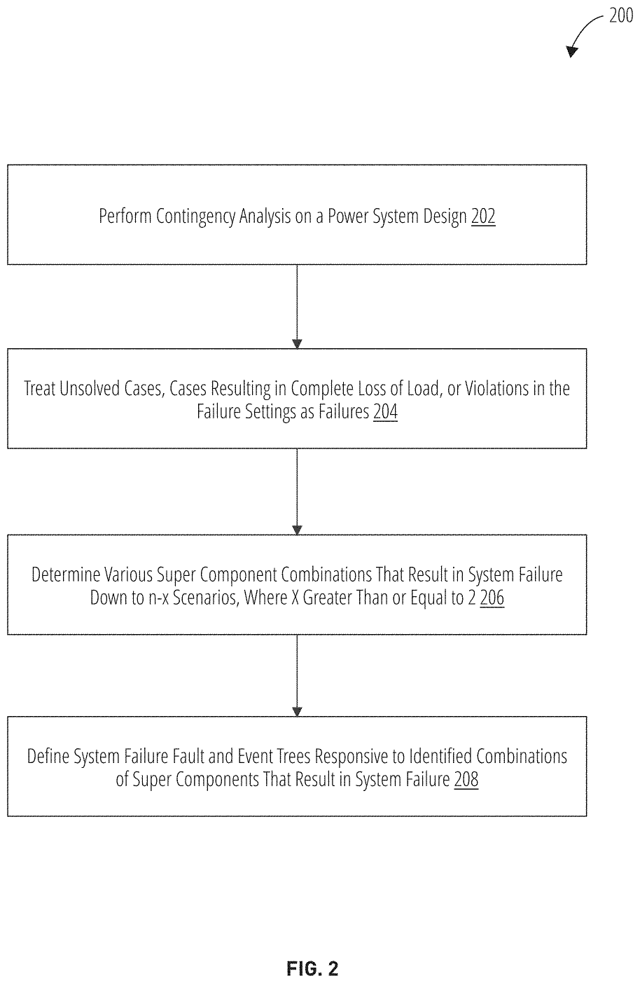

FIGS. 2, 3 and 4 are flowcharts that show an embodiment of a process flow for analysis of a power system, and more specifically, power flow contingency analysis in accordance with one or more embodiments of the disclosure. The analysis shown in FIGS. 2, 3 and 4 may be performed, for example, by a computer configured in accordance with computing platform 100 of FIG. 1.

In one or more embodiments, power flow contingency analysis is performed for n scenarios, probability of super component failure is performed for up to n−2 of the scenarios, and a calculation of the overall probability of system wide outage as well as the probability of specific failure scenarios are determined. The EcUs (and components within) that experienced the largest change in adaptive capacity in addition to the tightest constrained ECUs are determined. By detecting EcUs that exhibit large changes in adaptive capacity with information from the n−1 case, power flow models may be further used to investigate relevant n−2 contingencies such as the compromise between the reliability of power flow to load vs the resilience of the system under various conditions. Modifications to the system, such as additional super components, may be analyzed to determine (e.g., including predicting) if the modifications would enhance reliability and resilience of the system during likely scenarios.

FIG. 2 shows a power flow simulation process 200, in accordance with one or more embodiments.

Turning to FIG. 2, in operation 202 a contingency analysis is performed on a power system design. In one embodiment, the contingency analysis is performed on a power system model corresponding to the power system design, for a number of scenarios. Non-limiting examples of scenarios include vandalism, islanding, distribution interruption, physical attack, generation inadequacy, transmission interruption, systems operations, and severe weather. Non-limiting examples of severe weather scenarios include wild fires, floods, tornado, thunderstorms, winter storm, hurricanes, high winds, and undefined weather (weather patterns that have no easy category but which are identifiable in the data).

In operation 204, any unsolved scenarios, scenarios resulting in complete loss of load, or volitions in the failure settings are identified and treated as failures. In one embodiment, system tolerances may be provided (i.e., pre-specified) for failure settings that are used in operation 204. Failure settings are specified conditions (e.g., set by a user) that are deemed failures, for example, bus voltage levels vis-a-vis nominal voltage, and current flow vis-a-vis rated line ampacity.

In operation 206, various super component combinations that result in system failures are determined down to n−2 scenarios.

In operation 208, the failed combination of super components that resulted in a system failure determined in operation 206 are used to define system failure for “fault and event trees.” In one or more embodiments, characteristics are captured for aggregating adaptive capacity in local regions (i.e., ECUs).

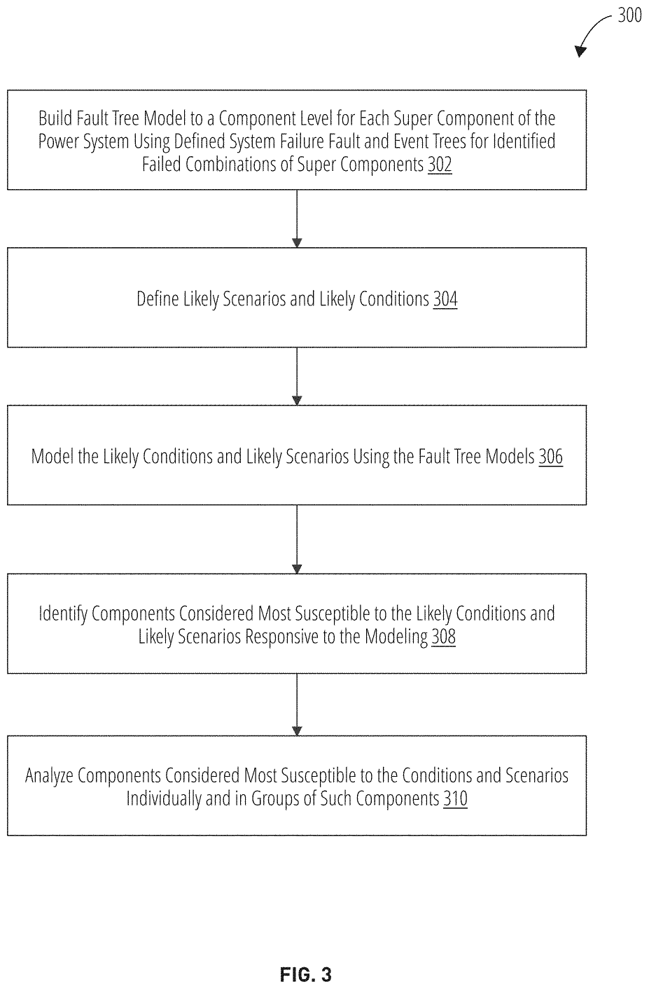

FIG. 3 shows a probability risk assessment process 300, in accordance with one or more embodiments.

In operation 302, a fault tree model is built (or received) to a component level for each super component/major function of the power system based on the components identified operation 206 of power flow simulation process 200. For example, and as noted above, super components in a power grid may include one or more of transformers, power lines, power supply, capacitors, and breakers.

In operation 304, likely conditions and likely scenarios given those conditions are determined. In one embodiment, likely conditions and scenarios may be determined by performing a probability analysis using information about super component combinations that result in power system failures determined in operation 206.

In operation 306, the likely conditions and the likely scenarios given those conditions determined in operation 304 are modeled using fault tree models built in operation 302.

In operation 308, components considered most susceptible to the likely conditions and likely scenarios are identified responsive to the modeling of operation 306.

In operation 310, components considered most susceptible to the conditions and scenarios identified in operation 308 are analyzed individually and as groups using modeled responses generated using the fault tree models in operation 306.

Electric power is typically transported using two different types of power lines: distribution lines and transmission lines. Distribution lines are for short distances, their voltages are lower (as compared to voltages of transmission lines), and they transport power locally. Transmission lines are for large distances, their voltage is higher (as compared to voltages of distribution lines), and they transport more electricity.

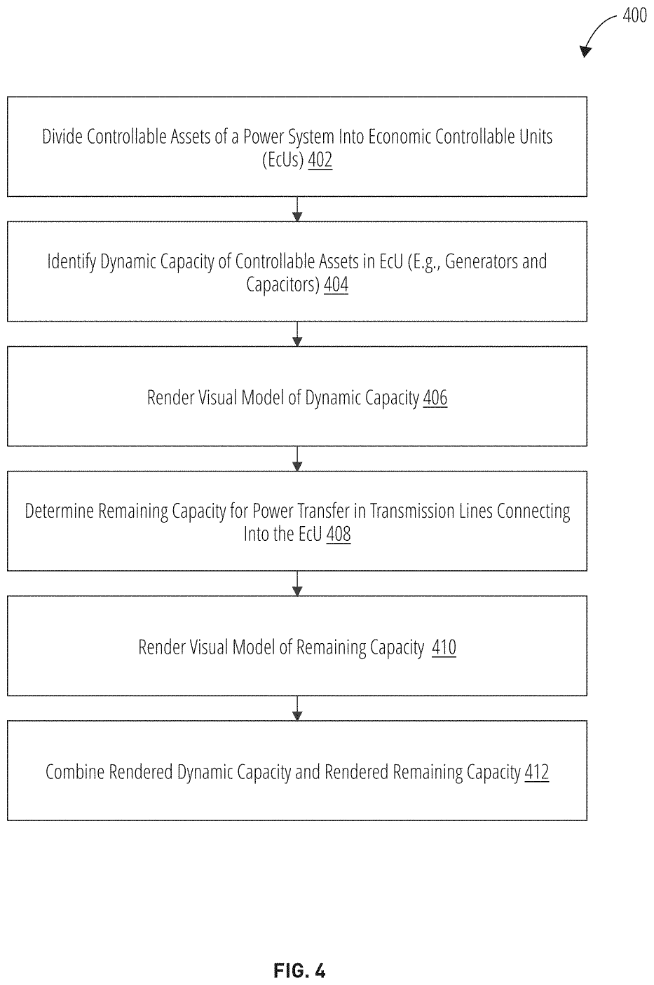

FIG. 4 shows a flowchart of a process 400 for visualization of the power system analysis (as discussed with reference to FIG. 2 and FIG. 3) for a transmission system, in accordance with one or more embodiments.

In operation 402, a power system model is broken up, logically, into EcUs. In one embodiment, the power system is broken up by dividing controllable assets of the power system into EcUs.

In operation 404, dynamic capacity of controllable assets of each EcU are identified. As a non-limiting example, dynamic capacity may be determined based, at least in part, on generator limits and synchronous compensators. In operation 406, a visual model of dynamic capacity of the controllable assets is rendered. In operation 408, remaining capacity for power transfer in transmission lines connecting into each EcU. In operation 410, a visual model of the remaining capacity is rendered. In operation 412, the rendered dynamic capacity and rendered remaining capacity are combined. The combined visual model being a model of adaptive capacity.

The resulting aggregation of the two parts in a three-dimensional space depicting the adaptive capacity limits.

By describing the limits of each of the ECUs the sensitivity to a localized disturbance may be illustrated (i.e., increased load or loss of a generation asset). This information may be used to determine which ECUs, in theory, would benefit from strengthening transmission or additional distributed assets. In one embodiment, the ECU's which undergo the largest change in adaptive capacity from the nominal case to each of the n−1 contingencies is selected.

In one or more embodiments, impact of geographic considerations for failure data used in probability risk assessment may be evaluated. The considerations of the dynamic changes such as whether balancing the generation with loads can occur fast enough after a disturbance to stabilize characteristics of a power system (e.g., frequency, voltage, amperage), may also be performed. In one embodiment, an iterative process may be used to identify the most critical improvements desired in a component's reliability and or adaptive capacity to maximize system wide enhancements in reliability and reliance.

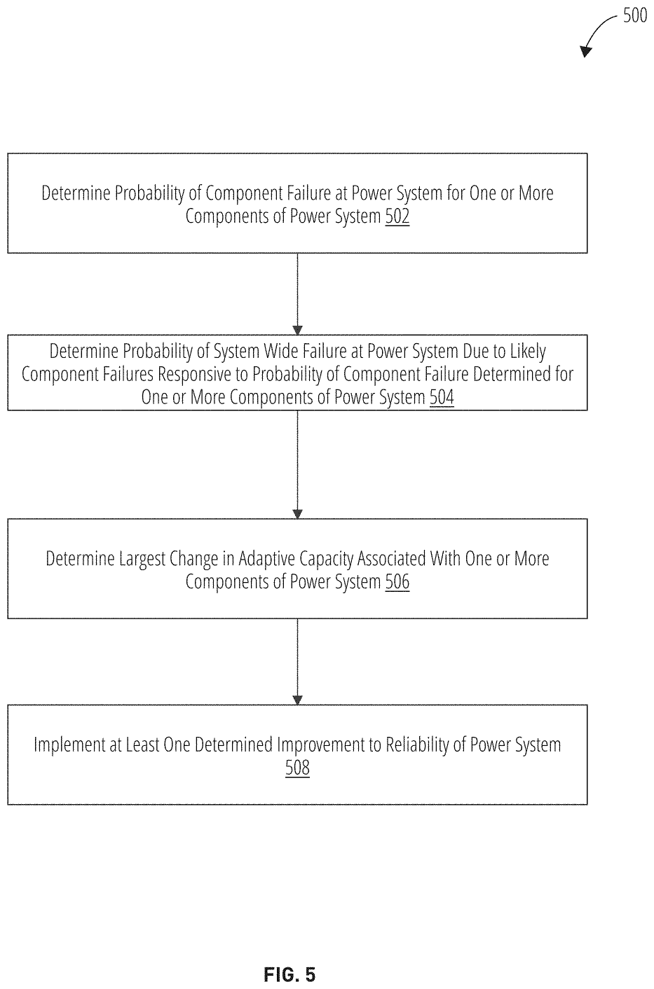

FIG. 5 shows a process 500 for identifying opportunities to improve a power system using power system analysis in accordance with one or more embodiments of the disclosure.

In operation 502, a probability of component failure at a power system for one or more components of the power system is determined.

In operation 504, a probability of system wide failure at the power system due to likely component failures is determined responsive to the probability of component failure determined for the one or more components of the power system of operation 502.

In operation 506, a largest change in adaptive capacity associated with the one or more components of the power system is determined. In one embodiment, one or more modifications to one or more components may be determined and the change in adaptive capacity determined by re-performing one or more of operations 502 and operation 504 with the one or more modifications implemented.

In operation 508, at least one determined improvement to reliability of the power system is implemented. In one embodiment, modifications in one embodiment, the modifications may be implemented in a power system diagram corresponding to the analyzed power system.

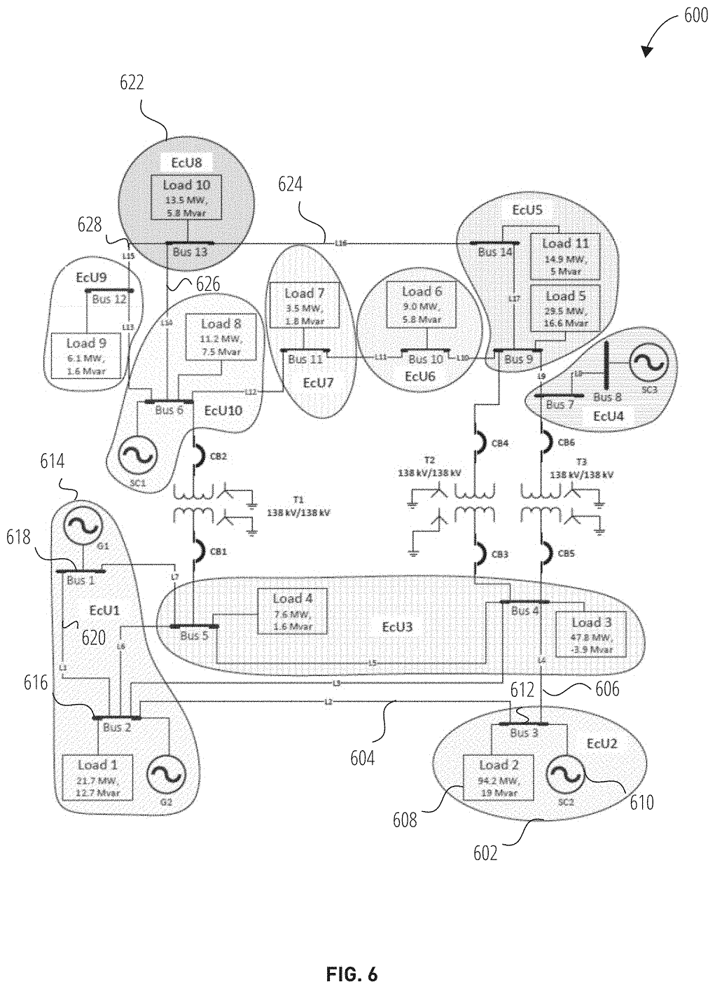

FIG. 6 shows a diagram of a transmission system 600 of EcUs grouped in accordance with one or more embodiments. In particular, transmission system 600 is a bus system currently under specification by the Institute of Electrical and Electronics Engineers (IEEE) as IEEE 14 bus system.

As shown in FIG. 6, controllable assets of transmission system 600 are divided topologically into EcUs, and more specifically, EcU1 through EcU9, on a bus-by-bus basis. In some cases, where buses have a low impedance line due to a short transmission line, they have been grouped into a single EcU (here, EcU1, EcU3, EcU4, and EcU5). So, using EcU 614 as an example, EcU 614 includes two buses, bus 616 and bus 618, because there is a short transmission line, line 620 connecting bus 616 and bus 618.

Controllable assets within EcUs of transmission system 600 include generators and synchronous compensators. Using EcU 602 as an example, EcU 602 is identified based on bus 612, and includes synchronous compensator 610 and generator 608, which are connected to, and connected to each other by, bus 612. Two transmission lines are connected into EcU 602, line 606 and line 604. Dynamic capacity of E generator 608 is shown in FIG. 6 by two characteristics, real power (here, 94.2 MW), and reactive power (19 MVAR). Remaining capacity for transmission of power to EcU 602 may be determined by converting line amperage load for line 604 and line 606 to apparent power using, e.g., a nominal bus voltage.

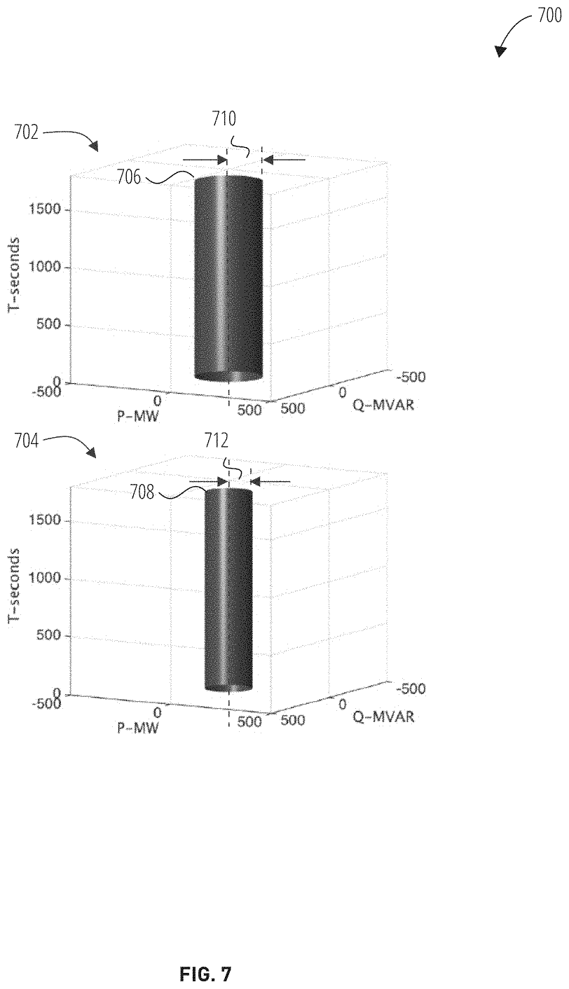

FIG. 7 shows example graphs 700 of renderings of adaptive capacity of EcU 622 (i.e., EcU8 of transmission system 600) over a period of time corresponding to a modeled disturbance, here, a windstorm.

Graph 702 shows a model 706 for adaptive capacity of EcU 622 under “normal” conditions. Graph 704 shows model 708 for adaptive capacity of EcU 622 under an abnormal condition, namely, line 624 fails and so at least part of remaining capacity of EcU 622 depends on available power from line 628 and line 626.

In FIG. 7, adaptive capacity of EcU 622 under the normal and abnormal conditions is illustrated by a radius of respective model 706 and model 708. For example, adaptive capacity at a given time for model 706 is shown by radius 710, and adaptive capacity at a given time for model 708 is shown by radius 712.

So, a change in adaptive capacity from a failure of line 624 is inherently illustrated in graphs 700 by a difference in radius 710 and radius 712 of model 706 and model 708.

One of ordinary skill in the art will appreciate that “media,” “medium,” “computer-readable media,” or “computer-readable medium” as used here, may include a diskette, a magnetic tape, a digital tape, a compact disc, an integrated circuit, a ROM, a CD, DVD, Blu-Ray, a cartridge, flash memory, PROM, a RAM, a memory stick or card, or any other non-destructive storage medium useable by computers, including those that are re-writable.

Although the enabling software might be “written on” a disc, “embodied in” an integrated circuit, “carried over” a communications circuit, “stored in” a memory chip, or “loaded in” a cache memory, it will be appreciated that, for the purposes of this application, the software will be referred to simply as being “in” or “on” the computer-readable medium. Thus, the terms “in” or “on” are intended to encompass the above mentioned and all equivalent and possible ways in which software can be associated with a computer-readable medium.

For the sake of simplicity, therefore, the term “computer program product” is thus used to refer to a computer-readable medium, as defined above, which has on it any form of software to enable a computer system to operate according to any embodiment of the present disclosure. Software applications may include software for facilitating interaction with software modules, including user interface and application programming interfaces. Software may also be bundled, especially in a commercial context, to be built, compiled and/or installed on a local computer.

Certain embodiments of the present disclosure were described above. It is, however, expressly noted that implementation of the present disclosure is not limited to those embodiments, but rather additions and modifications to what was expressly described herein are also included within the scope of the disclosure.

Any characterization in this disclosure of something as ‘typical,’ conventional,′ or ‘known’ does not necessarily mean that it is disclosed in the prior art or that the discussed aspects are appreciated in the prior art. Nor does it necessarily mean that, in the relevant field, it is widely known, well-understood, or routinely used.

Moreover, it is to be understood that the features of the various embodiments described herein were not mutually exclusive and can exist in various combinations and permutations, even if such combinations or permutations were not made express herein, without departing from the scope of the disclosure. In fact, variations, modifications, and other implementations of what was described herein will occur to those of ordinary skill in the art without departing from the scope of the disclosure. As such, the present disclosure is not to be defined only by the preceding illustrative description, but only by the claims, which follow, and legal equivalents thereof.

1. A computer-implemented method, comprising:
determining a probability of component failure at an infrastructure system for one or more components of the infrastructure system;
determining a probability of system wide failure at the infrastructure system due to likely component failures responsive to the probability of component failure determined for the one or more components of the infrastructure system; and
determining a largest change in adaptive capacity associated with the one or more components of the infrastructure system.

2. The computer-implemented method of claim 1, further comprising evaluating contingencies for the one or more components associated with the largest change in adaptive capacity.

3. The computer-implemented method of claim 1, further comprising:
analyzing modifications to the infrastructure system at a component level and determining improvements, if any, to reliability and reliance of the infrastructure system responsive to the analyzed modifications.

4. The computer-implemented method of claim 3, further comprising:
implementing at least one determined improvement to reliability of the infrastructure system.

5. The computer-implemented method of claim 1, wherein determining the probability of component failure at the infrastructure system for one or more components of the infrastructure system comprises:
determining the probability of component failure at the infrastructure system for a component responsive to a modeled response of the component to one or more scenarios.

6. The computer-implemented method of claim 5, further comprising modeling a response of the component to one or more disturbances.

7. The computer-implemented method of claim 6, wherein the disturbances comprise one or more of extreme weather, earthquakes, explosions, attacks, vandalism, islanding, generation inadequacy, and interruptions to transmission or system operations.

8. The computer-implemented method of claim 1, further comprising:
identifying a component associated with the largest change in adaptive capacity;
determining a modification to the identified component; and
analyzing an improvement in adaptive capacity responsive to the modification to the identified component.

9. The computer-implemented method of claim 1, wherein the infrastructure is one or more of: a power system, an information technology system, a water distribution system, a security system, and an oil and gas pipeline.

10. A computer program product including a computer-readable media, the computer-readable media including instructions for performing an infrastructure system analysis that, when executed by a computer, cause the computer to:
determine a probability of component failure at an infrastructure system for one or more components of the infrastructure system;
determine a probability of system wide failure at the infrastructure system due to likely component failures responsive to the probability of component failure determined for the one or more components of the infrastructure system; and
determine a largest change in adaptive capacity associated with the one or more components of the infrastructure system.

11. The computer program product of claim 10, wherein the instructions are further configured to cause the computer to: evaluate contingencies for one or more contingencies responsive to the one or more components associated with the largest change in adaptive capacity.

12. The computer program product of claim 10, wherein the instructions are further configured to cause the computer to: analyze modifications to the infrastructure system at a component level and determining improvements, if any, to reliability and reliance of the infrastructure system responsive to the analyzed modifications.

13. The computer program product of claim 12, wherein the instructions are further configured to cause the computer to: implement at least one determined improvement to reliability of the infrastructure system.

14. The computer program product of claim 10, wherein the infrastructure comprises one or more of: a power system, an information technology system, a water distribution system, a security system, and an oil and gas pipeline.

15. The computer program product of claim 10, wherein the instructions are further configured to cause the computer to: model a response of at least one component of the one or more components to one or more disturbances.

16. The computer program product of claim 15, wherein the disturbances comprise one or more of: extreme weather, earthquakes, explosions, attacks, vandalism, islanding, generation inadequacy, and interruptions to transmission or system operations.

17. The computer program product of claim 10, wherein the instructions are further configured to cause the computer to:
identify a component associated with the largest change in adaptive capacity;
determine a modification to the identified component; and
analyze an improvement in adaptive capacity responsive to the modification to the identified component.

18. The computer program product of claim 10, wherein the infrastructure is one or more of: a power system, an information technology system, a water distribution system, a security system, and an oil and gas pipeline.
